(19) United States
(12) Patent Application Publication
(10) Pub. No.: US 2018/0154597 A1
(43) Pub. Date: Jun. 7, 2018

(54) METHOD FOR MAKING A V-BELT

(71) Applicant: ContiTech Antriebssysteme GmbH, Hannover (DE)

(72) Inventors: Ymte Greydanus, Barsinghausen (DE); Peter Lindemann, Hannover (DE); Tim Fiss, Hannover (DE)

(21) Appl. No.: 15/884,234

(22) Filed: Jan. 30, 2018

Related U.S. Application Data
(63) Continuation of application No. PCT/EP2016/054838, filed on Mar. 8, 2016.

(30) Foreign Application Priority Data
Jul. 30, 2015 (DE) 102015214492.5

(51) Int. Cl. B29D 29/10; B32B 37/08; B32B 37/10; B32B 7/06; B32B 37/06

(52) U.S. Cl. CPC B29D 29/103; B32B 37/08; B32B 2413/00; B32B 7/06; B32B 37/06; B32B 37/10

(57) ABSTRACT

A method for making a V-ribbed belt is made by inserting a first partial blank in the form of a base tube into a cylindrical vulcanization mold having a negative of a V-ribbed profile. The first partial blank is molded into a surrounding negative and thus provided with the V-ribbed profile without vulcanization. A second partial blank made as a top ply tube with a tension strand is inserted into the virtually completely molded-in base tube and is expanded under heat and pressure so that the top ply tube and the base tube are bonded to one another. Thereafter, the latter is molded into the surrounding negative of the vulcanization mold, and the top ply tube and the base tube are vulcanized to form a V-ribbed blank, whereafter the V-ribbed blank is removed from the vulcanization mold and is fed to the cutting device.

### CROSS REFERENCE TO RELATED APPLICATIONS

This application is a continuation application of international patent application PCT/EP2016/054838, filed Mar. 8, 2016 designating the United States and claiming priority from German application 10 2015 214 492.5, filed Jul. 30, 2015, and the entire content of both applications is incorporated herein by reference.

### FIELD OF THE INVENTION

The invention relates to a method for making a V-ribbed belt, in which method the V-ribbed belt is cut in the form of a ring from a tube-like V-ribbed blank on a cutting device.

### BACKGROUND OF THE INVENTION

A method of this type, in which the V-ribbed belt is normally cut as a ring from a cylindrical V-ribbed blank, the length of which thus corresponds to a multiple of the belt width, a distinction is made in the production of the V-ribbed blank between substantially two methods, specifically the grinding method and the molding method.

In the case of the grinding method, a V-ribbed blank with a smooth surface is, after the complete vulcanization and prior to the cutting-off of the rings, subjected to a material-removing machining process (grinding), whereby the ribbed profile is formed on the outer side of this V-ribbed blank, specifically into the so-called base.

By contrast, in the case of the molding method, the ribbed profile of the V-ribbed blank is produced already during the vulcanization process, specifically by means of a cylindrical vulcanization mold which, on its inner side, has the negative of the ribbed profile, into which the V-ribbed blank is pressed before or during the vulcanization.

After being produced, the V-ribbed blanks produced in the molding or grinding process thus initially have the V-ribbed profile on their outer side. After the individual rings have been cut off from the V-ribbed blank, the rings are “turned inside out”, such that their profiled side lies on the inner side. One thus obtains the drive belt, commonly referred to as V-ribbed belt, which, by means of its profiled inner side, drives complementarily configured belt pulleys, and to the back side of which tensioning rollers or further drives are possibly connected in force-fitting fashion.

The present invention relates to a V-ribbed belt or V-ribbed blank produced in a molding method and of relatively small dimensions, that is, with a circumference which does not significantly exceed approximately 1400 millimeters.

In the case of conventional molding methods, the V-ribbed blank is built up on a so-called belt building drum. With regard to the further manufacturing process and the subsequent “turning inside out”, it is self-evidently firstly necessary for the back side of the belt, specifically the so-called top ply, to be built up on the drum. The latter may be built up in one or two layers and provided with various additives or coatings.

The so-called “tension strand” composed of one or more strengthening members is then applied to the top ply. The strengthening members are normally composed of one or more fibers, filaments or cords folded or twisted around one another, and are wound in one or more layers, in windings of greater or lesser tightness, over the entire width of the belt building drum. In the finished belt, the strengthening members are crucial for the transmission of tensile force and are then situated in the regions between the top ply and the base, which will be described below.

The so-called “base” or main body of the V-ribbed belt, that is, the region which later has the ripped profile and possibly also a small further layer thickness, is applied to the tension strand. Here, the base is applied in the form of a thin plate composed of elastomer material/rubber, the width of which corresponds to the length of the belt building drum, and the length of which approximately corresponds to the circumference of the belt building drum. The ends of the plate can be easily joined together when in the still-tacky state.

Finally, a fabric ply is often also applied, which provides special characteristics for the finished V-ribbed belt in the profile region, for example contributes to noise or friction reduction. The fabric ply thus completes the V-ribbed blank.

The thus produced non-vulcanized assembly composed of top ply, tension strand and base and possibly fabric ply is then inserted into the cylindrical vulcanization mold, which is of slightly greater diameter, such that the base or the fabric ply faces toward the inner side, provided with a negative of the ribbed profile, of the vulcanization mold. A sleeve, normally composed of rubber, and corresponding devices for the expansion of the sleeve and for the heating of the latter, normally feed means and devices for subjecting the sleeve to compressed air and for subjecting the normally double-walled vulcanization mold to hot steam, are then inserted into the inner cavity of the vulcanization mold.

The sleeve is then expanded by means of the hot steam, bears against the top ply and presses the entire V-ribbed blank into the surrounding negative of the vulcanization mold, whereby the outer layer of the V-ribbed blank, specifically the base or the fabric ply, is pressed into the negative and is thus provided with a “molded” ribbed profile. Here, the tension strand is however subject to considerable expansion, as will be discussed again further below.

V-ribbed belts, the profile of which is coated with a fabric ply, can be used in an exceptionally versatile manner and, by means of their fabric ply coating, can be optimally adapted even to arduous usage situations. Such V-ribbed belts can however be expediently produced only by means of the molding method, because it has hitherto not been possible to satisfactorily achieve the application of a fabric ply after a grinding process.

During the production in accordance with the molding method, the strengthening members/the tension strand must permit adequate expansion in order that the base can be pressed into the negative of the ribbed profile on the inner side of the mold and the ribbed profile of the V-ribbed blank can form. Polyester fibers, for example, exhibit adequate expansion in this context. For a long time, strengthening members in the tension strand have thus been formed for example from polyester fibers, filaments or polyester cords.

Nowadays, however, there is an ever-increasing change to using different materials of higher strength, such as for example glass fibers or high-strength aramide fibers. For certain usage situations, in which there is a demand for V-ribbed belts which exhibit high strength and small expansion, such as for example in the case of use in an automatic start-stop system in a motor vehicle, the use of such high-strength fibers is increasingly necessary.

However, if it is now sought in the case of relatively short V-ribbed belts, such as are used for example in an automatic start-stop system, to combine the advantages of fabric plies on the profile (profile coating), which necessitates production using the molding method, with the use of high-strength fibers, a person skilled in the art encounters considerable difficulties, or a conflict of aims, in the production of such short V-ribbed belts.

The above-described expansion, required for the molding method, of the V-ribbed blank must specifically be relatively great in order that the base can fully nestle into the negative of the cylindrical vulcanization mold and precisely form the profile. The expansion approximately corresponds, in terms of its magnitude, to the profile depth. While it is the case for the elastomer material, the still-unvulcanized rubber, that the great expansion does not constitute a problem, the wound/coiled tension strand is highly loaded and must therefore be composed of a material which permits such a considerable expansion. The tension strand is therefore normally composed of polyester yarns.

While it is the case for V-ribbed blanks of large diameter that such an expansion is possible even with relatively high-strength fibers with lower expansion capability than polyester, problems arise in the production of V-ribbed blanks of relatively small diameter, that is, for short V-ribbed belts. Here, it is specifically the relative expansion that is of importance, that is, the expansion in relation to the diameter of the V-ribbed blank. The smaller the diameter of the V-ribbed blank, that is, the shorter the belt that is later formed, the greater, in the case of an approximately unchanged profile depth, is the relative expansion of the tension strands during the pressing of the base into the profile negative of the cylindrical vulcanization mold. The tension strand as strengthening member in the V-ribbed belt would thus have to jointly perform a great relative expansion in order to not impede the molding process. However, for a small circumferential length of the vulcanization mold, the tension strand must be correspondingly expandable. A short belt therefore cannot be produced with a high-strength tension strand, but only with a soft, expandable tension strand, by means of the molding method.

Thus, with the use of glass fibers or aramide fibers for short V-ribbed belts, the limits of the conventional production method are quickly reached. A disadvantageous effect may for example consist in that the cords or strengthening members penetrate into the top ply mixture and thus change the belt structure, the belt construction. In this respect, only polyester yarns have conventionally been used as a tension strand for short V-ribbed belts.

A solution to this problem is presented by DE 10 2013 110 053 A1 which is incorporated herein by reference. The document discloses a drive belt, the tension strand of which has cords which are constructed from at least two different yarns with respectively different moduli and thus different expansion behavior, in particular from a high-modulus yarn which exhibits small expansion and a low-modulus yarn which exhibits great expansion. A disadvantage of the solution is that, in each case, a highly targeted adaptation of the yarns to the individual situation is necessary, and that it is also only possible for certain regions to be adapted.

### SUMMARY OF THE INVENTION

It is an object of the invention to provide a method for making a V-ribbed belt which permits the use of the molding method for, inter alia, profile-coated short V-ribbed belts with tension strands composed of high-strength fibers.

This object is achieved by making the V-ribbed blank by the following method steps:
a) a first partial blank in the form of a base tube is produced or fabricated such that the ends of a plate composed of non-vulcanized elastomer material are joined together in overlapping fashion and with a joint formed so as to be preferably inclined over the thickness of the plate,
b) the first partial blank in the form of the base tube is inserted into a cylindrical vulcanization mold which is equipped on its inner side with the negative of a V-ribbed profile, wherein, into the inner cavity of the base tube, there are inserted an expandable tube-like sleeve and devices for the expansion of the sleeve and for the heating of the base tube, preferably feed means and devices for the expansion and of the sleeve with compressed air and for the heating of the vulcanization mold with hot steam,
c) the sleeve is expanded under the action of heat and pressure to such an extent that the base tube is virtually completely molded into the surrounding negative of the vulcanization mold and is thus virtually completely equipped with the V-ribbed profile,
d) after the molding of the V-ribbed profile, cooling is performed by virtue of further heating of the base tube being ended, without vulcanization of the base tube occurring,
e) a second partial blank is fabricated, as a top ply tube, on a belt building drum by virtue of a top ply which later forms the belt backing of the V-ribbed belt being applied and a tension strand composed of one or more strengthening members being wound in one or more plies onto the top ply over the entire width of the belt building drum, wherein the top ply tube (together with tension strand) has an outer diameter slightly smaller than the inner diameter of the virtually completely molded-in base tube,
f) the second partial blank in the form of the top ply tube is removed from the belt building drum and, after removal of the sleeve from the cylindrical vulcanization mold, is inserted into the latter and into the virtually completely molded-in base tube,
g) the expandable tube-like sleeve and corresponding feed means and devices for the expansion of the sleeve and of the overall assembly, surrounding this sleeve, composed of top ply tube and base tube are inserted into the inner cavity of the top ply tube again,
h) the sleeve is expanded under the action of heat and pressure to such an extent that the top ply tube and the base tube are connected to one another, and the latter is molded completely into the surrounding negative of the vulcanization mold,
i) the top ply tube and the base tube are completely vulcanized with one another to form a V-ribbed blank by means of a further supply of heat and pressure/supply of hot steam, following which the V-ribbed blank is removed from the vulcanization mold and is fed to the cutting device.

In terms of its general basis, the invention consists in particular in the conventionally used single-stage production method discussed above, in which the base tube and top ply tube connected to one another are, in one step, provided with the molded ribbed profile and vulcanized, being split into a two-stage method, in which the molding of the V-ribbed profile on the outer side of the base tube is performed separately during the course of a pre-molding (pre-forming) step.

### BRIEF DESCRIPTION OF THE DRAWINGS

The invention will now be described with reference to the drawings wherein:

FIGS. 1 to 4 show the basic steps of the inventive two-stage method, in which the molding of the V-ribbed profile on the outer side of the base tube is performed separately during the course of a pre-molding (pre-forming) step.

### DESCRIPTION OF THE PREFERRED EMBODIMENTS OF THE INVENTION

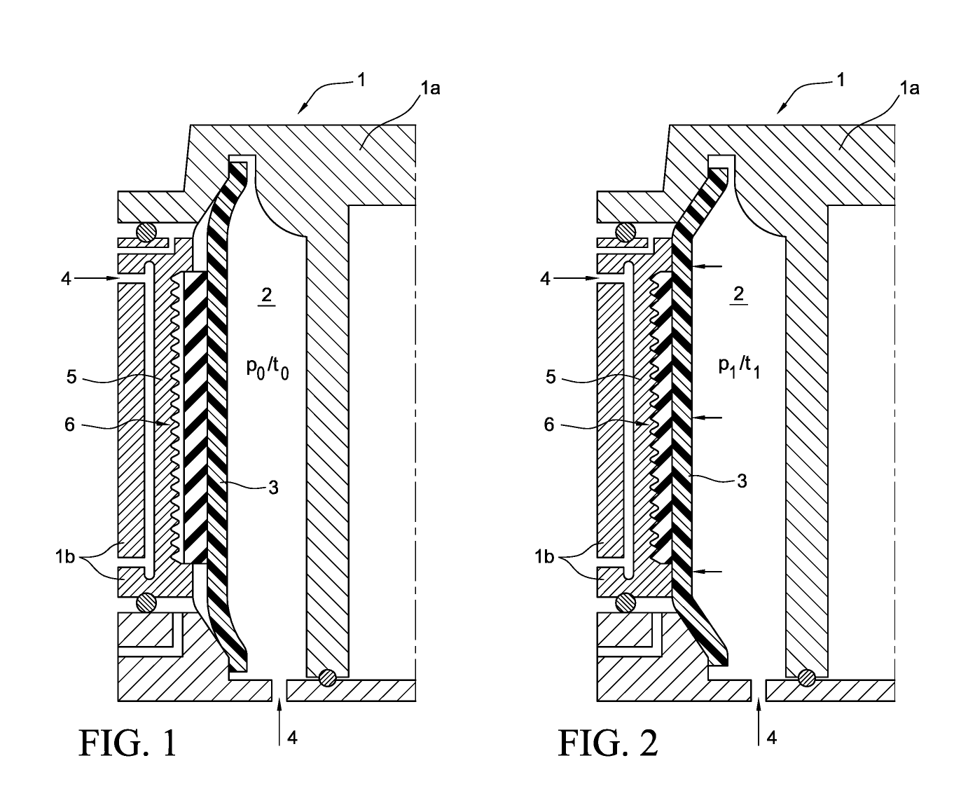

FIG. 1 shows the left half of a cylindrical vulcanization mold 1 as a cross section. Vulcanization mold 1 substantially includes the cylindrical mold parts 1a and 1b, the mold parts 1a and 1b forming an inner cavity 2. The inner cavity 2 is equipped with an expandable tube-like sleeve 3 and is connected to appropriate devices for the expansion of the sleeve and for the heating the inside of cavity and the walls of the mold. The heating is preferably done by hot steam 4 entering into heating channels of the mold part 1b and into the cavity 2. The expansion is done by feeding compressed air and/or compressed hot steam into the cavity 2.

The production of the V-ribbed blank is carried out as follows:

A first partial blank in the form of a base tube 5 is produced or fabricated such that the ends of a plate composed of non-vulcanized elastomer material are joined together in overlapping fashion and with a joint formed so as to be preferably inclined over the thickness of the plate.

This first partial blank in the form of the base tube 5 is inserted into the cylindrical vulcanization mold 1 where the inner side of mold part 1b is equipped with the negative profile 6 of a V-ribbed profile. During insertion there is a temperature t₀ and a pressure p₀ in the cavity.

The expandable tube-like sleeve 3 is situated inside, i.e. inside the inner cavity of the base tube 5. After expansion and heating of the sleeve 3 and heating of the vulcanization mold 1 with hot steam, the sleeve 3 is expanded under the action of heat and pressure to such an extent that the base tube 5 is virtually completely molded into the surrounding negative profile 6 of the vulcanization mold part 1b and is thus virtually completely equipped with the V-ribbed profile. FIG. 2 shows this step, where increased molding temperature t₁ and a molding pressure p₁ are present in the cavity 2 and also the mold 1 is heated to molding temperature or slightly above.

After the molding of the V-ribbed profile, cooling is performed by virtue of further heating of the base tube being ended, without vulcanization of the base tube 5 occurring.

On another belt building drum, not depicted here, a second partial blank is fabricated, as a top ply tube, which later forms the belt backing of the V-ribbed belt being applied and a tension strand composed of one or more strengthening members being wound in one or more plies onto the top ply over the entire width of the belt building drum, wherein the top ply tube 7 (together with tension strand) has an outer diameter slightly smaller than the inner diameter of the virtually completely molded-in base tube 5.

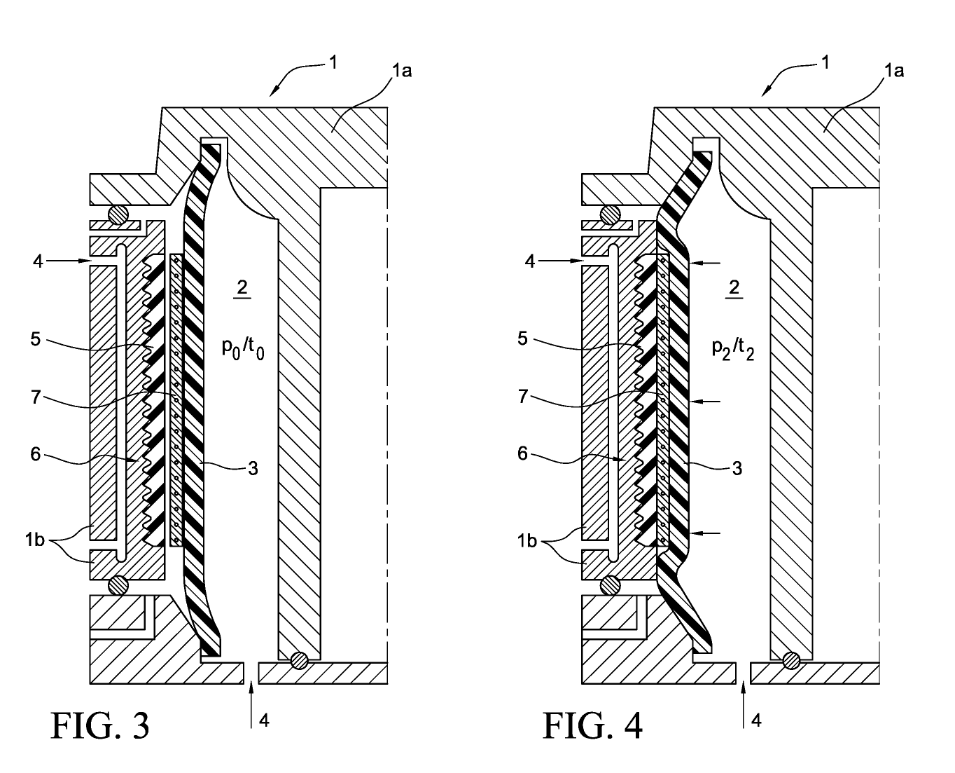

The second partial blank in the form of the top ply tube 7 is then removed from the belt building drum and, after removal of the sleeve 3 from the cylindrical vulcanization mold 1, is inserted into the latter and into the virtually completely molded-in base tube 5. As shown in FIG. 3, the expandable tube-like sleeve 3 and corresponding feed means and devices for the expansion of the sleeve and of the overall assembly, surrounding said sleeve, now composed of top ply tube 7 and base tube 5 are inserted into the inner cavity of the top ply tube again. During this step of insertion again a temperature of around t₀ and a pressure p₀ is present in the cavity.

Again the sleeve 3 is expanded under the action of heat and pressure to such an extent that the top ply tube 7 and the base tube 5 are connected to one another, and the latter is molded completely into the surrounding negative of the vulcanization mold part 1b. In this action, shown in FIG. 4, the top ply tube 7 and the base tube 5 are completely vulcanized with one another to form a V-ribbed blank by means of a further supply of heat and pressure/supply of hot steam. During this final vulcanization and connection of the tubes 5 and 7 an increased molding temperature t₂ and a molding pressure p₂ are present in the cavity and also the mold 1 is heated to this molding temperature.

After this final vulcanization, the completed V-ribbed blank is removed from the vulcanization mold 1 and is fed to a cutting device, not depicted here.

The two-stage method according to the invention in which the molding process of the base tube, by means of which the V-ribbed profile in the base tube is virtually completely molded, and the vulcanization and remaining molding process, for the overall assembly of top ply tube and base tube, are separated from one another has the effect that, during the molding of the V-ribbed profile on the negative on the inner side of the cylindrical vulcanization mold, the expansions required for this purpose are not transmitted to the tension strand. Specifically, the tension strand is situated on the top ply tube, which is connected to the base tube only later, that is, after the V-ribbed profile has been virtually completely molded in, with minimal expansion being imparted for the remaining molding process, and the overall assembly is supplied for complete molding and vulcanization.

The considerable relative expansion required for the major part of the molding process, which expansion approximately corresponds in terms of its magnitude to the profile depth, therefore does not need to be accommodated by the tension strand, only by the base tube.

The tension strand, which is indeed situated on the outer side of the top ply tube which is inserted into the base tube after the molding of the latter, then only has to accommodate a minimal expansion, which is necessary for the connection of the top ply tube to the base tube and for the remaining molding process. The magnitude of this “minimal expansion” can, during the fabrication process, be easily influenced by virtue of the outer diameter of the top ply tube being brought as close as possible to the inner diameter of the base tube formed after the molding-in of the V-ribbed profile. The outer diameter of the top ply tube is thus selected such that the latter can just be inserted without any difficulties into the base tube in the vulcanization mold.

The major advantage of this two-stage method consists in that, with corresponding configuration, it is even possible to use tension strands composed of aramide or glass fibers. It is thus possible by means of this method according to the invention to produce V-ribbed blanks of small diameter, that is, ultimately very short V-ribbed belts, which have all the advantages of the molding method, without encountering the problems with the relative expansion of the tension strand. It is thus possible for all advantages of the molding method, such as for example targeted and adapted profile coating by means of fabric plies et cetera, to also be used for short, highly loaded V-ribbed belts.

An advantageous embodiment consists in that the strengthening members of the tension strand are composed of fibers or yarns which exhibit small expansion, preferably of glass fibers or aramide fibers. As already discussed above, it is thus possible to produce high-strength short V-ribbed belts with a very low modulus of expansion, for example for high loads in an automatic start-stop system of a motor vehicle. In such applications, a low modulus of expansion is imperatively necessary in order to prevent slip phenomena or transmission delays during starting operation.

A further advantageous embodiment consists in that, on the outer side of the first partial blank or base tube, there is applied a further layer, preferably a fabric ply for providing special profile characteristics. By means of the application of such a layer, the characteristics during the operation of the V-ribbed belt can be influenced. For example, fabric plies are suitable for positively influencing the friction characteristics of a V-ribbed belt of this type and thus also the noise characteristics. For particular usage situations, it is also possible to apply for example polyethylene coatings or other friction-minimizing layers.

A further advantageous embodiment consists in that, on the inner side of the first partial blank or base tube, there is applied a further layer, preferably a release foil or a protective foil which is impermeable to release agent. Such a layer yields advantages in the further production method according to the invention in that release agents that are possibly applied to the sleeve introduced into the cylindrical vulcanization mold cannot ingress into the material of the base tube. The release foil or the protective foil/coating that is impermeable to release agent is then removed again before the insertion of the top ply tube.

A further advantageous embodiment consists in that the first partial blank is produced in the form of a base tube on a table separate from the belt building drum, wherein the joint is preferably joined together by means of a pressing device. In this way, it is possible for the base tube and top ply tube to be manufactured in parallel, such that the production process as a whole is accelerated.

A further advantageous embodiment consists in that the top ply of the second partial blank is produced on a table separate from the belt building drum and is then applied to the belt building drum, where the strengthening members are then wound on. This embodiment, too, serves for the adaptation of the manufacturing flow by means of further splitting-up of the production process into individual shorter manufacturing steps.

A further advantageous embodiment consists in that, during the winding-on of the tension strand, a solution is applied to, preferably sprayed in a flow-regulated manner onto, the strengthening members, which solution effects a connection between top ply and tension strand. This often involves a so-called “dip”, by means of which the adhesion and connection of the tension strand to the surrounding material matrix are intensified.

A further advantageous embodiment consists in that the circumference of the first partial blank or of the virtually completely molded-in base tube is less than 1400 mm, preferably less than 1200 mm. In this way, short V-ribbed belts with high-strength fibers and exhibiting extremely small expansion for use in highly loaded drives are formed after the individual V-ribbed belts are cut off from the V-ribbed blank.

It is understood that the foregoing description is that of the preferred embodiments of the invention and that various changes and modifications may be made thereto without departing from the spirit and scope of the invention as defined in the appended claims.

What is claimed is:

1. A method for making a V-ribbed belt, wherein the V-ribbed belt is cut in the form of a ring from a tube-like V-ribbed blank on a cutting device, the method comprising the steps of:
a) a first partial blank in the form of a base tube is produced or fabricated such that the ends of a plate made of non-vulcanized elastomer material are joined together in overlapping fashion and with a joint formed so as to be preferably inclined over the thickness of the plate;
b) the first partial blank in the form of the base tube is inserted into a cylindrical vulcanization mold which is equipped on its inner side with a surrounding negative of a V-ribbed profile, wherein, into the inner cavity of the base tube, there are inserted an expandable tube-like sleeve and corresponding devices for the expansion of the sleeve and for the heating of the base tube, these devices including feed devices and devices for the expansion of the sleeve with compressed air and for the heating of the vulcanization mold with hot steam;
c) the sleeve is expanded under the action of heat and pressure to such an extent that the base tube is virtually completely molded into the surrounding negative of the vulcanization mold and is thus virtually completely equipped with the V-ribbed profile;
d) after the molding of the V-ribbed profile, cooling is performed by virtue of further heating of the base tube being ended, without vulcanization of the base tube occurring;
e) a second partial blank is made, as a top ply tube, on a belt building drum by virtue of a top ply which later forms the belt backing of the V-ribbed belt being applied and a tension strand of one or more strengthening members being wound in one or more plies as a tension strand onto the top ply over the entire width of the belt building drum, wherein the top ply tube together with tension strand has an outer diameter slightly smaller than the inner diameter of the virtually completely molded-in base tube;
f) the second partial blank in the form of the top ply tube is removed from the belt building drum and, after removal of the sleeve from the cylindrical vulcanization mold, is inserted into the latter and into the virtually completely molded-in base tube;
g) the expandable tube-like sleeve and corresponding feed means and devices for the expansion of the sleeve and of the overall assembly, surrounding the sleeve, composed of top ply tube and base tube are inserted into the inner cavity of the top ply tube again;
h) the sleeve is expanded under the action of heat and pressure to such an extent that the top ply tube and the base tube are connected to one another, and the latter is molded completely into the surrounding negative of the vulcanization mold; and,
i) the top ply tube and the base tube are completely vulcanized with one another to form a V-ribbed blank by a further supply of heat and pressure and/or a supply of hot steam,
following which the V-ribbed blank is removed from the vulcanization mold and is fed to the cutting device.

2. The method of claim 1, wherein the strengthening members of the tension strand are made of fibers or yarns which exhibit small expansion, preferably of glass fibers or aramide fibers.

3. The method of claim 1, wherein, on the outer side of the first partial blank or base tube, there is applied a further layer, preferably a fabric ply for providing special profile characteristics.

4. The method of claim 1, wherein, on the inner side of the first partial blank or base tube, there is applied a further layer, preferably a release foil or a protective foil which is impermeable to release agent.

5. The method of claim 1, wherein the first partial blank is produced in the form of a base tube on a table separate from the belt building drum, wherein the joint is preferably joined together by means of a pressing device.

6. The method of claim 1, wherein the top ply of the second partial blank is produced on a table separate from the belt building drum and is then applied to the belt building drum.

7. The method of claim 1, wherein, during the winding-on of the tension strand, a solution is applied to, preferably sprayed in a flow-regulated manner onto, the strengthening members, which solution effects a connection between top ply and tension strand.

8. The method of claim 1, wherein the circumference of the first partial blank or of the virtually completely molded-in base tube is less than 1400 mm.

9. The method of claim 1, wherein the circumference of the first partial blank or of the virtually completely molded-in base tube is less than 1200 mm.
